(19) United States
(12) Patent Application Publication
(10) Pub. No.: US 2023/0097092 A1
(43) Pub. Date: Mar. 30, 2023

(54) METHOD AND SYSTEM OF VIDEO CODING WITH INLINE DOWNSCALING HARDWARE

(71) Applicant: Intel Corporation, Santa Clara, CA (US)

(72) Inventors: Shriram S. Deshpande, Rancho Cordova, CA (US); Satya N. Yedidi, Roseville, CA (US); James M. Holland, Folsom, CA (US); Dmitry E. Ryzhov, Mountain View, CA (US); Jian Hu, El Dorado Hills, CA (US); Sai Agnihotri, Newark, CA (US); Indira Munagani, Portland, OR (US)

(73) Assignee: Intel Corporation, Santa Clara, CA (US)

(21) Appl. No.: 17/978,290

(22) Filed: Nov. 1, 2022

(51) Int. Cl. H04N 19/124; H04N 19/52; H04N 19/184

(52) U.S. Cl. CPC H04N 19/124; H04N 19/52; H04N 19/184

(57) ABSTRACT

Techniques related to video encoding include inline downscaling hardware in multi-pass encoding.

### BACKGROUND

Ultra-low latency image data networks, where delay is maintained at a sub-second, are used to process a very high volume of data packets with an extraordinarily low tolerance for delay or latency. The ultra-low latency networks can support real-time access and respond to rapidly changing data. Thus, ultra-low latency networks are very beneficial for streaming video without latency that may reduce performance and quality of the viewing experience.

An ultra-low latency network for video encoding may need a second pass (based on a first pass bitstream size) for encoding in order to meet a target constant bit rate per frame. A first full resolution pass is used to assess key frame statistics such as the actual quantization parameters (QPs) used as well as the complexity and motion of content of video frames being compressed. The statistics then can be used in one or more subsequent encoding passes, also at full resolution, to adjust the QPs and preset prediction data to better ensure that a final encoded frame has a bitstream size that meets strict tolerance limitations. The use of full resolution frames in two passes, however, significantly increases latency and in turn, negatively impacts performance.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example multi-pass encoding system according to at least one of the implementations herein;

FIG. 2 is a schematic diagram of an example source fetch unit of a multi-pass encoding system according to at least one of the implementations herein;

FIG. 3 is an example cache line requestor of the source fetch unit of FIG. 2 and according to at least one of the implementations herein;

FIG. 4 is a diagram showing an example pixel image data arrangement in an order to be downscaled according to at least one of the implementations herein;

FIG. 5 is another diagram showing an alternative example pixel image data arrangement in an order to be downscaled according to at least one of the implementations herein;

FIG. 6 is a schematic diagram showing components of the multi-pass encoding system of FIG. 2 including a local buffer according to at least one of the implementations herein;

FIGS. 7A-7B is a flow chart of an example method of image processing with multi-pass encoding according to at least one of the implementations herein;

FIG. 8 is a schematic diagram of an example encoder according to at least one of the implementations herein;

FIG. 9 is a schematic diagram showing a conventional time line of conventional multi-pass encoding;

FIG. 10 is a schematic diagram showing an example time line of multi-pass encoding according to at least one of the implementations herein;

FIG. 11 is a flow chart of another example method of image processing with multi-pass encoding according to at least one of the implementations herein;

FIG. 12 is a schematic diagram of an image processing system according to at least one of the implementations herein;

FIG. 13 is a schematic diagram of an example system; and

FIG. 14 is a schematic diagram of another example system, all according to at least one of the implementations herein;

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes unless stated otherwise. For instance, various architectures employing, for example, multiple integrated circuit (IC) chips and/or packages, and/or various computing devices and/or consumer electronic (CE) devices such as servers, computers, laptops, tablets, TVs, set top boxes, smart phones, and so forth, may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

Some of the materials disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as DRAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

The terms “substantially,” “close,” “approximately,” “near,” and “about,” generally refer to being within +/- 10% of a target value. For example, unless otherwise specified in the explicit context of their use, the terms “substantially equal,” “about equal” and “approximately equal” mean that there is no more than incidental variation between among things so described. In the art, such variation is typically no more than +/-10% of a predetermined target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

Methods, devices, apparatuses, computing platforms, and articles are described herein related to video coding and, in particular, to inline downscaling hardware for video encoding.

As described above, multi-pass encoding may be used to derive statistics from a first pass that can be used to set encoder settings in a second pass. Such statistics may include actual QP usage as well as measurement of the complexity of the image content that can be used in the second pass to control the bitrate. An encoder typically attempts to maintain an average bitrate, bitrate range between a maximum and minimum bitrate, and/or target video file size while providing the best quality images possible. If a given frame is completely different from a previously encoded picture in a video sequence, the encoded frame size could be much larger than the target bit stream size forcing a second pass. Thus, in the second pass, a quantization parameter (QP) can be adjusted accordingly for the frame with the scene change. The full frame first pass encoding, however, causes significant latency such that real time encoding of high quality images can result in noticeable delays and pauses in the playback of the video.

Conventional attempts to reduce latency include the use of statistics from a previous frame encode to predict parameters for encoding a current frame. While this approach is adequate during a scene, when the current frame is significantly different from the previous frame over a scene change, the current frame size in bits will be too large since encoder parameters, such as the frame-level QP, are being set according to the prior frame, thereby resulting in surpassing a target bitrate for the current frame. In this case, the current frame is re-analyzed anyway with tighter bitrate constraints resulting in uncertain latencies from frame to frame.

By another conventional technique, a software external downscaling of the image data may be performed before providing the downscaled image data for the first encoding pass. Specifically, the downscaled image data may be written to off-chip RAM or even non-volatile memory where it can be read for the encoding. This technique results in significant increases in latency and power consumption. Also, this solution has more complex software because it requires the additional task of ensuring that the external downscale operation is complete before starting the first encode pass. This is necessary for external memory because an encoder usually wait for a flag signal to ensure completion of the encoder downscale operation. This can be achieved by way of polling for a downscale completion flag to start encoding the current frame.

To resolve these issues, the disclosed video coding system and method implements inline downscaling hardware and local memory in a multi-pass, such as two pass, encoder pipeline to downscale input frames of a source video sequence. The downscaled frames then may be encoded in a first fast pass to generate statistics and determine encoder settings for a second full resolution encoding pass. By one form, the hardware downscaling is internal on-chip downscaling that may be performed on dedicated-function downscaling circuitry without using downscaling applications or software or the use of external downscaling hardware to perform the downscaling itself. Also, the downscaling may be performed without the need to place downscaled image data of the frames into external off-chip memory before encoding the downscaled image data. This internal downscaling may be referred to as on-the-fly downscaling where no external downscaling operation (in software) is being performed to generate a downscaled frame to be encoded for statistics. Software refers to a software package, code, instruction set, and/or instructions as mentioned below.

The downscaling hardware also may be used to simultaneously downsample a number of different color space subsampling schemes to another subsampling scheme with fewer chroma pixels, for example where schemes 444 and 422 can be converted to 420 to further reduce the computational load and in turn latency of the first pass. In addition, the output can be fixed at a certain fixed bit depth such as eight bits per pixel (for a chroma or luma value) regardless of the input bit size (such as 10, 12, or 16 bits) per pixel to further ensure a faster more efficient first encoding pass.

The downscaled first pass may be performed by using encoder settings (or encoder state programming) provided in, or based on, the downscaled frame size including inter-prediction reference frame sizes, while the encoder settings in the second pass may be provided in the full resolution or non-downscaled frame size. The encoder settings that may be set by using statistics from the downscaled first pass include the quantization parameter (QP) or other related quantization settings, and/or prediction data such as intra or inter-prediction data including motion estimation (ME) data or motion vectors (MVs), although other parameters could be set as well.

With this multi-pass downscaling arrangement, the disclosed system and method significantly reduces latency and can be used in real-time applications since the first pass consumes a much smaller computational load to downscale, compress, and analyze a smaller downscaled frame than compress and analyze a full resolution frame. Also, the arrangement simplifies or eliminates the software requirements and dependencies from the conventional techniques. The arrangement herein also significantly reduces power consumption and increases performances due to the downscaled frame size and on-the-fly hardware-based downscaling that reduces the memory capacity and memory transaction requirements.

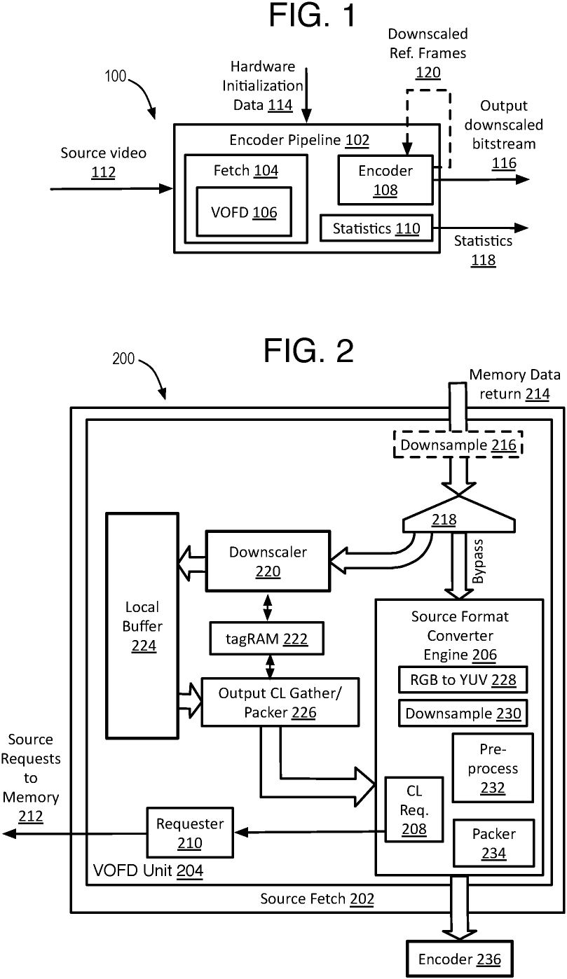

Referring to FIG. 1 for more details, an image processing system 100 may include a multi-pass encoder pipeline 102, often providing two passes, that can be used for image transmission for many different applications. For example, such an encoder pipeline 102 may be used for ultra-low latency applications such as game streaming, E-sports betting, education front board streaming, webinars, video conferencing, IP camera streaming, mobile streaming, auctions, live commerce or shopping, telehealth conferencing, digital fitness classes, and other highly interactive live streams with real-time engagement applications where maintaining a substantially constant bitrate per frame is a high priority to avoid noticeable delays in image transmissions.

Specifically, ultra-low latency applications, such as game streaming and other real time applications, may benefit from the multi-pass downscaling encoder pipeline 102 when a constant or substantially constant frame bit rate is needed and from frame to frame in order to maintain high performance. Otherwise, low power look-ahead bit rate control may benefit from the disclosed pipeline 102 where such a bit rate control looks into future frames for complexity and distributes available bandwidth among many frames to maximize the visual quality. The disclosed pipeline 102 can assist to reduce the time and computational load and power consumption to determine the frame complexities. In addition, the disclosed pipeline 102 may assist with prediction in the subsequent pass by efficiently determining prediction data or parameters in the first pass. Thus, the motion vectors found in the first pass may be used directly or to expand or change motion search regions for inter prediction in the subsequent pass, as well as using downscaled reference frames generated in the first pass. Likewise, the selection of spatial neighbor blocks could be determined in the first pass and used for intra prediction in the subsequent passes.

The image processing system or device 100 may be implemented as any suitable device such as, for example, server, a personal computer, a laptop computer, a tablet, a phablet, a smart phone, a digital camera, a gaming console, a wearable device, a display device, an all-in-one device, a two-in-one device, or the like. For example, as used herein, a system, device, a video coding device, computer, or computing device may include any such device or platform.

The encoder pipeline 102 may have a fetch unit (or source fetch unit) 104 that includes a video encoding on-the-fly downscaling unit (or VOFD) 106, an encoder 108, and a statistics unit 110. The encoder 108 may compress downscaled video frames in a fast first pass and full resolution images in a second pass, and the statistics unit 110 may analyze the data of the first pass to set encoder settings for the second pass. The VOFD 106 may be a standalone functional hardware block that is instantiated in the hardware encode pipeline 102 in the source fetch unit 104 to perform on-the-fly downscaling of source pixels to be used for a first fast encode pass. By one form, the VOFD 106 being standalone refers to the VOFD operating without any software control or dependency, although instructions may be provided on the VOFD in firmware and hardware initialization may include programming a scale factor.

One example source video 112 of a sequence of video frames, each with image data, is shown to be input to the encoder pipeline during a fast first encoding pass (or just first pass). Frames may be characterized interchangeably as pictures, images, video pictures, sequences of pictures, video sequences, etc. A scale factor may be applied and may be input to downscaling hardware to downscale the source video 112. The scale factor is not necessarily limited by the resolution of the source video 112, and may be set to achieve a desired downscaled resolution for the video for first pass encoding. The source video 112 may be have any resolution such as 720 HD, 1440 QHD, 1080 full-HD, 4 K, 8 K, and so forth. By one example form, downscaling may be used for frame sizes greater than 512 × 256 pixels. A single scale factor may be applied for encoding per frame, per group of pictures (GOPs), per scene, or other video division. The same downscaling hardware or circuitry can support multiple scale factors by reusing hardware gates or logic as needed and as described below.

Hardware initialization (or state programming) data, instructions, or signals 114 may have encoder setting surfaces or data such as encoder settings or frame-level programming used by the encoder to perform the encoding. For example, the hardware initialization data 114 may include a target bitrate on a frame level, sequence level, or both, frame height, tile width, slice level state, and so forth. Downscaled reference frames 120 from the first pass also may be provided by encoder 108 and stored in a frame buffer and then provide back to the encoder 108 for the subsequent pass. By one form, the hardware initialization hardware initialization data 114 may provide state programming for fast first encoding pass that is based on a downscaled frame size while the hardware initialization data 114 may provide surface and other state programming or data that may be based on the full resolution source surface for the subsequent pass. For one possible example, say source video is provided in full HD (920×1080) resolution to be downscaled for the first pass, and the scale factor is ×4 (per side) or 16× or 16:1 (total area). Herein for clarity, downscaling referred to by a side of a block of pixels (or linear downscaling) will have the ‘x’ before the scale factor (e.g., ×4), and downscaling referring to total area of a block of pixels will be designated with the ‘x’ after the scale factor (e.g., 16×). In this case, the image date 114 may be provided in, or based on, a target downscaled size of 480 × 270 pixels, and the downscaled frame size and resulting output bitstream (as well as the basis for the output statistics analyzing the first pass encoding) also is 480 × 270 pixels.

The source video 112 may include any video sequence for encode. Such video may include any suitable video frames, video pictures, sequence of video frames, group of pictures (GOPs), video data, or the like in any suitable resolution. The encoding techniques used herein may be performed by using frames, blocks, and sub-blocks, and so forth of pixel samples (typically square or rectangular) in any suitable color space such as YUV.

By one form, the source video may be provided in one subsampling color scheme or space and converted to another for encoding in the fast first pass. For example, source video 112 may be provided in 444 format and then converted to 420 format. By one form, each Y/U/V (or R/G/B) channel of the source video 112 may be input to the encoder pipeline (or downscaler) separately. For example, a picture or frame of color video data may include a luminance plane (or component, surface, or channel) and two chrominance planes (or components, surfaces, or channels) at the same or different resolutions with respect to the luminance plane. The video may include pictures or frames that may be divided into blocks of any size, which contain data corresponding to blocks of pixels. Such blocks may include data from one or more color or luminance channels of pixel data. It should be noted that luminance, luma, and brightness are used interchangeably herein and are meant in a general sense without consideration of whether or not gamma correction has been applied.

With the encoding pipeline as described, the present system and methods are able to provide a fast encode pass for any input source format (such as 444, 422, or 420, and 8, 10, or 12 bit depth) that can be downscaled to a specific target format, such as NV12 420, 8 bit format for example, for power reduction and increased performance. The fast first encoding pass does not need full chroma subsampling support and extended bit depths, in contrast to the format of the version of the source video used in the subsequent full resolution pass. The present methods and system also may include a one shot simultaneous downscaling and downsampling feature to convert 444 or 422 formats to 420 format as described in detail below.

Referring to FIG. 2, an image processing system or device 200 has a source fetch unit 202 with a VOFD unit 204, similar to source fetch unit 104 with VOFD unit 106. The VOFD unit 204 may have a source format converter engine 206. The VOFD unit 204 also may have a cache line (CL) request unit 210, an optional color subsampling scheme downsampling unit 216, a bypass switch 218, at least one downscaler (or downscaler unit or downscaling circuitry) 220, at least one local buffer or memory 224, a tagRAM unit 222, and a (buffer) output CL gather/packer 226. The engine 206 may have a CL request unit 208, an RGB to YUV conversion unit 228, a subsequent pass color space or downsampling unit 230, a pre-processing unit 232, and a packer unit 234.

The source fetch unit 202 transmits cache line source requests 212 to an external memory, and receives memory data returns 214 of the requested image data to be downscaled, and formatted as needed, by the VOFD unit 204. Resulting downscaled frames are then output and provided to an encoder 236.

In more detail, the CL request unit 208 of the engine 206 generates cache line request instructions to retrieve image data of a current frame of a source video to be encoded. This may include the use of existing cache line request instruction protocols accessible to the engine 206 to retrieve source pixel data from memory, except now the return data 214 is being diverted to a downscaler 220 rather than source format converter engine 206. Thus, the cache protocol may be used to obtain image data for downscaling in the first fast pass and such protocol instructions may be saved as firmware as part of the CL request unit 208. The returned data may be diverted to the downscaler 220 by a bypass switch 218 as explained below.

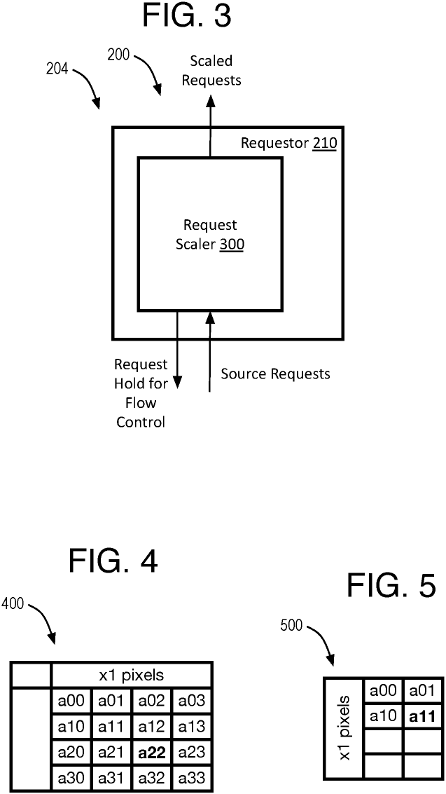

Referring to FIG. 3, the CL requests from the CL request unit 208 may be received by the requester unit 210. The requester unit 210 may have a request scaler 300 to scale the number of CL requests. The requestor unit 210 also may perform clamping when needed as well. Specifically, the number of initial CL requests from the engine 206 does not factor the downscaling relative to the capacity of the local buffer 204. In other words, the initial CL requests do not consider the downscaling factor that will be applied to the returned image data 214 before placing the downscaled image data into the local buffer 224. This could result in too few CLs being requested when the local buffer has a much greater capacity for downscaled image data. Therefore, the request scaler 300 may tap every input source cache line request from the engine 206 and scales the requests based on the programmed downscale mode (or scale factor). For example, if the scale factor is 16× (or 16:1) total area, a single cache line request is multiplied into 16 cache line requests even though this may be larger than the capacity of the local buffer 224. Since the downscaler will downscale the fetched image data in the CLs before the downscaled image data is placed into the local buffer 224, this will reduce the amount of image data of 16 CLs to generate a single downscaled CL that is the same size as a single initial CL from the engine.

In addition, while the CL request scaling is being performed, a delay signal is sent from the requester unit 210 back to the CL request unit 208 at the engine 206 in order to hold or stall the next source CL request (also referred to as a fetch engine request) until the scaled requests (here being the 16 requests in this example) are sent out to the memory in order to perform flow control. Otherwise, the requestor 210 will be overloaded with the initial CL requests.

The CL requests are transmitted to another source memory holding the source video 112. The source memory may be an external memory or buffer, whether volatile or non-volatile, another on-chip memory such as main RAM for example, or other memory arranged to hold initial full resolution video frames for encoding.

The source frame input (or returned memory data) 214 may be input as a memory surface starting with a specified base address. The format of the memory surface is dictated by the input source format including the subsampling color scheme (444, 422, or 420), bit depth, and tile mode of the returned data such as linear or tile for memory addressing. Some supported formats that may be used include AYUV, A410, ARGB10, NV12 luma or chroma, and P010 luma or chroma, to name a few examples. The image data to be downscaled can be in either RGB or YUV color spaces. The transmission of cache lines between components on the source fetch unit 202 whether linear or tile cache lines (CLs), as well as to other components such as encoder 236 may be on transmission circuitry of the source fetch unit 202 and other units. A linear cache line (CL) has pixels in a single row in raster scan order throughout an image, while the tile cache lines have a 2D tile of pixels each such as 16 × 4 = 64 bytes as one typical example. The pixel size of a cache line can vary depending on the memory format and bit-depth being used.

The memory data return (or returned image data or video frame portions) 214 are received by the VOFD unit 204. An optional preliminary subsample color scheme conversion unit 216 may be provided to convert 444 format to 420 format if not to be performed by simultaneous downscaling-downsampling by the downscaler 220 itself. The color scheme conversion may be performed in the downscaling first pass by using circuitry similar to the downscaling circuitry. The conversion circuitry may downsample chroma surfaces or channels by a color subsampling conversion factor ×2 (on a block side). For full resolution frames bypassing the downscaling in a subsequent pass, a color subsampling unit 230 may be used at the source format converter engine 206 instead.

A bypass switch 218 may direct the image to the downscaler 220 for a first pass or to the engine for a subsequent pass. Such a bypass switch 218 may be formed of known hardware logic and may be automatically triggered by a clock or set to automatically alternate the switch to a preset alternating of the first and subsequent passes. Otherwise, the switch 218 may be controlled by the engine or other processor that tracks whether returned data 214 is for downscaling for first pass or for full resolution use in a subsequent pass.

For a fast first pass, the returned image data 214 is provided to the downscaler (or downscaling circuitry) 220 with pixel image data in RGB, YUV, or other color space. The downscaler 220 may have registers to receive the image data from the returned cache lines. This may include a sufficient amount of registers to hold a maximum size downscaling pixel block such as 8 × 8, 16 × 16, 32 × 32, 64 × 64, and so forth. Tiled CLs or parts thereof may be loaded onto the downscaling pixel block of the downscaling circuitry 220 in the same 2D arrangement as in the tiled CL. Linear CLs may occupy a single line of the downscaling pixel block or may be loaded by an efficient order such as a raster scan order.

The downscaling circuitry 220 may have transistors, resistors, capacitors, and/or other components to form logic components of an accumulator or other structure that performs the downscaling, and this may depend on the type of downscaling algorithm or mode that is being used by the downscaling circuitry. For example, to compute average pixel values, summation or accumulation logic may be provided for a certain area, row, or column of the downscaling pixel block, while division logic may be provided as binary bit shifting circuitry.

Particularly, the downscaling circuitry 220 also may store at least one preset scale factor that may be input to the downscaler from hardware initialization data and saved as firmware by one example. In one approach, the same downscaling circuitry 220 may be adaptable to be used alternatively with many different scale factors, input formats, and bit-depths. The circuitry is arranged to generate intermediate (or partial) values, and final downscaled values. For example, for averaging circuitry, the system may change which pixel locations in a downscaling block of pixels is used to form a single average value depending on the scale factor. For example, the downscaling circuitry 220 may be able to hold a block of 8 × 8 pixels, and then depending on the scale factor may be able to output a single average value for the entire 8 × 8 block for 64× total area downscaling, four average values with one average value for every 4 × 4 pixels for 16× total area downscaling, or one average value for every 2 × 2 pixels for 4× total area downscaling.

For one specific example for 444 linear format, 8 bit source, and scale factor of ×4, each cache line may have 16 pixels of input data, which would be downscaled to generate 4 partial pixel values. Four such cache lines (in the y direction) may be accumulated to generate the final 4 pixel downscaled pixels.

For one specific example for 444 linear format, 10 bit source, and scale factor of s4, each cache line has 8 pixels of input data, which would be downscaled to generate 2 partial pixel values. Four such cache lines (in the y direction) then may be accumulated to generate the final 2 downscaled pixels.

It should be noted that the scale factor may be different depending on the color space (Y, U, or V) surface or channel and subsampling scheme 420 for example. When the downscaling circuitry 220 may be fixed to use a single scale factor, the scale factor may be set in firmware so that changing the scale factor simply may involve updating the firmware.

Alternatively, the downscaling circuitry 220 may be adaptable to use multiple alternative scale factors, and this may be implemented in a number of different ways and may depend on the downscaling algorithm that is being used. Likewise, the downscaling circuitry 220 could be fixed to use a single downscaling algorithm or may be adaptable to alternatively use different downscaling algorithms.

With regards to the alternative scale factors, while the example downscaling factor herein may be fixed at either ×4 or ×2, a selection between the two could be provided instead. The larger the scale factor, the more detail is sacrificed for better performance. Thus, while a scale factor of ×4 may provide better performance and less latency, the smaller scale factor ×2 will provide better quality images. For the fast first pass, however, a balance may be determined where quality can be sacrificed during the first pass in order to determine encoder settings or parameters that provide very significant reductions in latency and increases performance during the full resolution subsequent pass.

The alternative scale factors may be selected by providing a manual or automatic software decision or selection and to be placed into the hardware initialization data. This can be accomplished automatically such as having the system select the larger scale factor when a target bitrate is not being met. The decision may be automatically determined by encoder control systems or other image processing applications. Otherwise, a user may set performance settings that change the scale factor. By one possible alternative example, the scale factor may be changed by having multiple scale factors preset in firmware, and a software or firmware performance control switch or decision may be activated to select which scale factor is to be used.

With regards to the downscaling algorithm or mode, one example contemplates at least two different downscaling algorithms or modes including a bilinear average downscaling and a fixed pixel location downscaling. By one form, the downscaling circuitry 220 is fixed to use one of the modes, and by another approach, both modes are available on downscaling circuitry 220 and can be automatically selected by software, or manually set in the software, and for use during hardware initialization, for example.

Bilinear averaging computes the average pixel value for a block of pixels. By one example for a scale factor of ×4, a single average pixel value may be computed by the downscaler 220 for a 4 × 4 block of pixels as shown on the table below.

Table 1

| | | | | | |
|---|---|---|---|---|---|
| | ×1 pixels | | | | Intermediate pixels |
| ×1 pixels | a00 | a01 | a02 | a03 | Hₐᵥ₀ = (a00 + a01 + a02 + a03) »2 |
| | a10 | a11 | a12 | a13 | Hₐᵥ₁ = (a10 + a11+ a12 + a13) »2 |
| | a20 | a21 | a22 | a23 | Hₐᵥ₂ = (a20 + a21+ a22+ a23) »2 |
| | a30 | a31 | a32 | a33 | Hₐᵥ₃ = (a30 + a31+ a32 + a33) »2 |
| | | | | | Final pixel: AV=(Hₐᵥ₀ + Hₐᵥ₁ + Hav2 + Hav3) » 2 |

In this example, the downscaling circuitry 220 may have adders or sum logic for each row of the block, and then the resulting binary sum is bit-shifted to divide by the number of pixels in a row to get an intermediate average pixel value of a single row. The single row binary averages are then summed and bit-shifted to compute a single average value for the whole block as a downscaled pixel value placed into a downscaled CL forming a constructed downscaled image or surface. The downscaled CL may be constructed or collected at the local buffer 224 so that the downscaled pixels are collected at the buffer 224 pixel by pixel.

When the scale factor is changed for a bilinear mode, this can be implemented by the same adaptable downscaling circuitry 220. The change in scale factor simply causes a change in the number of times the downscaling circuitry is loaded. Each time the downscaling circuitry is loaded, an intermediate output average pixel value is generated. The intermediate values are then averaged to compute a final output downscaled pixel value for a large block of image data. No limit exists as to how many loads, and in turn, intermediate pixel values, can be computed for a single average final output pixel value.

Referring now to FIGS. 4-5, a fixed pixel location downscaling mode has the downscaling circuitry 220 select a same fixed one or more pixel locations relative to the size of the block being downscaled. Thus, for ×4 downscaling, every block of 4 × 4 pixels on an image surface 400 has the pixel a22 selected (in the third column and third row from the upper left-most pixel of a block). This pixel is selected as the downscale pixel for the block. Similarly, for ×2 downscaling, for every 2 × 2 block of pixels on an image surface 500, the lower right pixel a11 is the downscaled pixel for the block. Many variations are contemplated when it is known which rows, and columns, in an image, and in turn which rows in a pixel block at the downscaler has the fixed pixel location. In this case, only those CL requests for the pixel lines or rows, or portions of lines may be requested for the downscaler to simply read the fixed pixel location.

By yet another alternative, a true nearest neighbor downscaling method may be used where the averaging is performed as in the bilinear downscaling algorithm, except an additional operation is then performed to select a pixel value within the block that is closest to the average. This nearest neighbor pixel value is then used as the downscaled pixel, and this may be implemented when the circuitry is already complex and a gate count would be large, and otherwise with improve quality or performance compared to bilinear scaling. Other downscaling algorithms that could be used instead or as additional alternatives may be a maximum or minimum value within a pixel block.

By one alternative, more than one of the downscaling modes may be available at once, and one of the modes may be indicated in the hardware initialization data, or alternatively an otherwise through manual or automatic similar to selection of a scale factor when such an option is provided. So here again, one algorithm may be selected over another depending on image content complexity for example, or to increase performance. Thus the bilinear mode may provide better quality images versus better performance provided by the fixed interval mode.

When the downscaling modes are to be switched, it will be understood that the same bilinear average downscaling circuitry could be used for fixed pixel location downscaling instead. In other words, the same amount or size of a block of pixels may be input into the downscaling circuit, but instead of computing sums and averages, the image data of the pixel locations of the fixed pixel location interval downscaling is read and saved instead.

As described in one example in detail below, the scale factor may be inferred depending on the subsample color scheme, such as 444, to perform simultaneous downsampling of color subsampling scheme (such as from 444 to 420), such as by using an ×8 scale factor on the U and V channels when the scale factor on the Y channel is ×4. Otherwise, the scale factor could be selected.

By one form, the scale factor, downscaling algorithm, bit depth, and output color subsampling scheme may be selected and fixed depending on the image content expected to be used and whether performance or image quality is the higher priority. Also, by one form, the output of the downscaler 220 may be set to provide 8 bit depth image values and a 420 format for a variety of different input bit depths and formats. By one form, the downscaler 220 implements both the ×4 (4×4 to 1) or ×2 (2×2 to 1) downscale operations for input 420 formats.

The local buffer 224 may be a latch-based storage on the hardware or circuitry forming the VOFD unit 204. By one form, the buffer 224 may have a capacity to hold a certain block size expected by the encoder 236, such as two 32 × 32 blocks, and by one example, the image data may be stored in NV12 420 format. The buffer 224 may be a random access memory (RAM). By one form, the buffer may use an example interface including instructions such as write_enable, write_addr, write_data, read_addr, and read_data. The buffer may be sized to incoming cache lines in 420 or other format until all incoming requests for a given 32 × 32 (or other size) block are serviced.

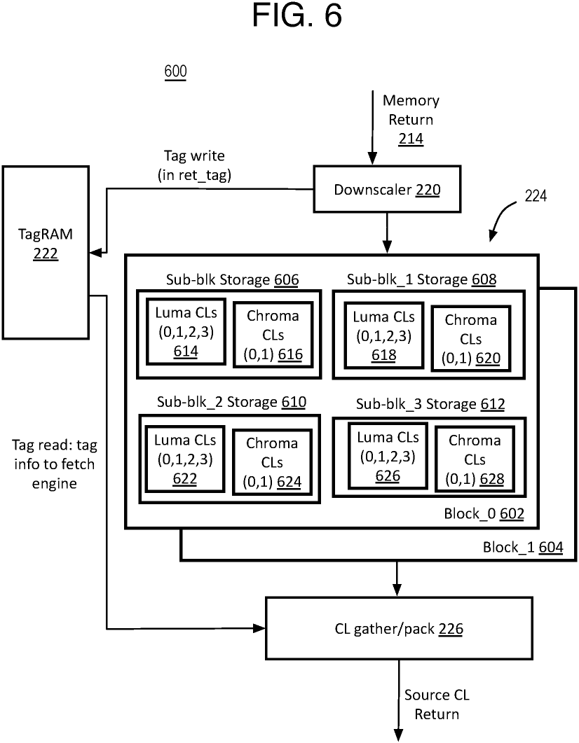

Referring to FIG. 6 for one example form, the local buffer 224 may store one or more fixed pixel blocks, and by one example, two fixed pixel blocks 602 and 604 in 420 format and may be 32 × 32 pixels, where each 32 × 32 block can be divided into smaller sub-blocks each for luma or chroma data, and such as four 16 × 16 sub-blocks 606, 608, 610, and 612. Each 16 × 16 sub-block 606, 608, 610, and 612 has a luma channel or surface 614, 618, 622, or 626 each with four luma CLs 0 to 3, and chroma surfaces or channels 616, 620, 624, or 628 each with two chroma CLs 0 and 1 including one CL for U and another CL for V in YUV color space and in 420 color subsampling scheme. The image values are 8-bit and the cache lines have a capacity of 64 bytes each in this example.

The example tagRAM 222 is one example structure that can be used to track the image data in the source fetch unit 202. The tagRAM 222 stores metadata used to track cache lines and cache line requests as well as buffer management. Specifically, the tagRAM 222 controls information such as tags used for scaling and tracking the cache lines from the downscaler 220 to the buffer 224, within the buffer 224, and from the buffer 224 to the engine 206 and CL gather/packer unit 234. Particularly, cache line returns may be received at the VOFD 204, and in turn downscaler 220, out of order. The tagRAM writes an address which is a fetch count and is sent as a ‘tag’ with a CL request. Upon data return, the tag is a return data packet that is read to identify the cache line, and in turn locate the cache line on a video frame. The tag can then be used to place and organize the cache lines within the buffer 224. This includes transmitting a tag write from the downscaler 220 to the tagRAM 222 in the form of a ret_tag identifying the returned cache line for example, or a tag_read sent to the CL gather/packer unit 226 to transmit the identity of the cache lines to the CL gather packer unit 226 so that the CL gather/packer unit 226 can collect the correct cache lines. The tagRAM 222 is needed in this context as the number of tag bits that go along with every CL request is limited (such as one) so that the additional metadata needed for CL tracking that does not fit in the tag going along with a CL request to memory is stored internally in the tagRAM 222 and read out as, and when, data returns are received from memory. More details of the tagRAM are provided below.

Once all the cache lines belonging to a current source 32×32 or 16×16 block are available, the Cache Line (CL) gather/packer unit 226 tracks the cache line data received for a complete 32 × 32 to activate chroma upsampling (through replication) as well as cache line gather and packing in the required output format. By one form, the CL gather/packer unit 226 pack dropped alpha channel bits and LSBs with place holders such as 0 s, as well as replicate chroma image values to generate a full cache line to be sent the encoder. The CL gather/packer 226 may be considered as part of the engine 206 rather than a separate unit or module as shown on FIG. 2.

Once expected (by the encoder 206 or similarly encoder 108) pixel blocks are packed, the engine 206 may perform pre-processing such as denoising, as well as RGB to YUV conversion by unit 228, and any other desired formatting for compatibility with the encoder 236. Such pre-processing may or may not use software at this point to modify pixel values. The downscaled frames, in the form of the blocks of pixels provided in cache lines then may be repacked by packer 234 when the data was modified by the pre-processing or formatting, and then provided to the encoder 236 to encode the downscaled frames in a fast first pass.

A statistics unit, such as the statistics unit 110, may be in software, firmware, or hardware to analyze the encoding. The statistics unit 110 may monitor the frame to frame bitrates that were actually used to compress the downscaled frames so that these bitrates may be used for the second full resolution pass. The statistics unit 110 also may save the prediction data that was used, such as motion estimation matching block results including motion vectors used for inter-prediction or block selection for intra-prediction, and prediction candidate selection when multiple candidates are considered. In addition, the statistics unit 110 also may perform image content complexity detection to detect scene changes and so forth to assist with adjusting the bitrate in the subsequent pass.

During a second full resolution pass, the source fetch unit 202 or 104 may fetch full resolution frames from an external frame buffer, and then provide the full resolution frames to the engine 206 for formatting and pre-processing as expected by the encoder. This may include RGB to YUV conversion and/or color scheme downsampling to 420 for example when such format is expected. The full resolution frames then may be provided to encoder 236 or 108 for encoding and where the hardware initialization data is based on a full resolution frame and includes encoder settings determined by using the statistics.

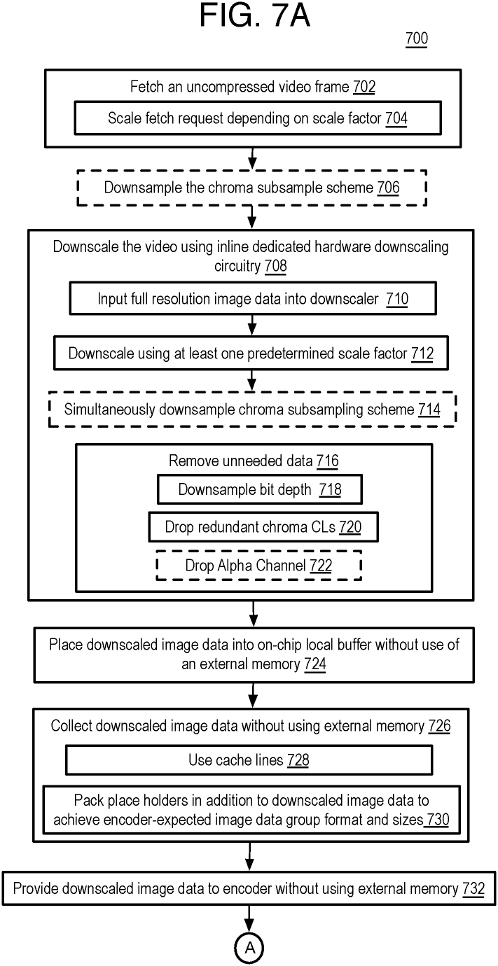

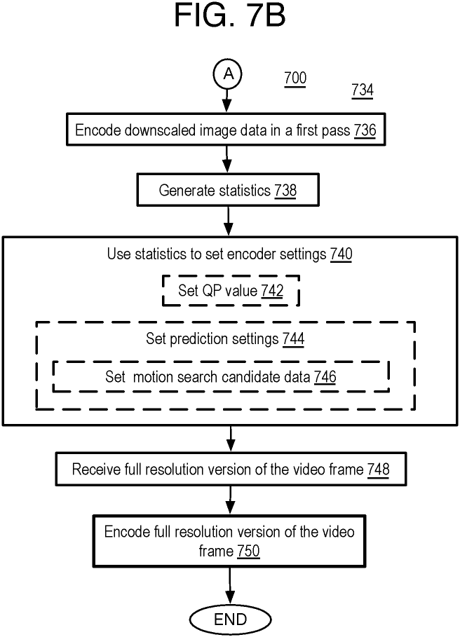

Referring to FIGS. 7A-7B, an example process 700 of video coding with inline downscaling hardware is described herein. In the illustrated implementation, process 700 may include one or more operations, functions, or actions as illustrated by one or more of operations 702 to 738, numbered evenly. By way of non-limiting example, process 700 may be described herein with reference to example image processing systems or devices 100, 200, 600, 800, and 1200 respectively of FIGS. 1, 2, 6, 8, and 12, where relevant.

As a preliminary matter, the use of the downscaler always may be on, or in the alternative, an automatic or manual activation may start the downscaling. Such a decision may be based on monitoring of bitrates and may activate the downscaling when target bitrates are not being met as one example. Otherwise, a user may turn the downscaling on by a manual switch (such as a selection in an application or manual encoder settings), or a manual activation may be triggered from certain image processing applications such as a rendering application.

Process 700 may include “fetch an uncompressed video frame” 702, and as described above, this may include “scale fetch request depending on scale factor” 704. The scaled cache line requests may be used to request a larger amount of data than a capacity of the local buffer since the data will be downscaled before being placed into the buffer. As mentioned above, this may involve the format engine of a hardware VOFD generating CL requests, sending the requests to a requester unit that upscales the number of requests, and in turn the amount of pixels being requested. By one form, the cache lines (CLs) may have a capacity of 64 bytes each, but the number of pixels in the CL is dependent on the input source format. For example, for NV12 color space, the luma CLs may have 64 bytes (8 bits per pixel), while the chroma CLs each may have 32 U pixels and 32 V pixels. On the other hand, for AYUV color space, one CL may have only 16 bytes (4 bytes per pixel). Also, the CLs may be in either linear format or tile format, where in linear format cache lines are assigned one after the other in rows of the pixels in a frame in raster scan order for example. In tile order, the cache lines are a 2D array of pixels as mentioned above.

Although the total number of cache line requests going to memory rises due to the upscaling of the requests and which impacts ‘per block’ performance in some target usages (such as a speed mode), the effective performance gain through downscaling is still significantly higher. For example, for an NV12 tile format, say 24 CL requests are issued by the source format converter engine. If the downscaling factor is ×4, then the CL requests may be upscaled by 16 to 384 CL requests, and upscaled to 96 CL requests with a downscaling factor of ×2.

By one alternative approach, the number of CL requests for liner formats can be reduced when using the fixed pixel downscaling mode or algorithm. Since this algorithm selects the pixel at a fixed location within each downscaling block, such as the 3^{rd} row and 3^{rd} column from the upper left pixel for ×4 downscaling (pixel a22 in FIG. 4) for example, then only the CLs with that key pixel location are needed, and the remaining CLs are considered invalid or redundant and do not need to be fetched. To state it another way, while four CL rows 0 to 3 could be fetched, only row 2 will be used in the present example with the pixel in the 3^{rd} row and 3^{rd} column of the downscaling block. The invalid or redundant CLs are dropped by the downscaler in this case. Thus, by only requesting those CLs with the key fixed pixel locations, this saves memory bandwidth, reducing power consumption, and improving performance. Continuing the example of NV12 linear format above, with the CL request reduction, 96 CL requests may be used for ×4 downscaling (rather than 384), and 24 CL requests may be used for ×2 downscaling (rather than 96).

Also as mentioned, the CL requests may be transmitted with tags added by a tagRAM and that can be used to track the CLs as the CLS are transmitted within the VOFD. The tags may be based on fetch counts. A fetch count indicates a position of the CL requested within a given source block of pixels. For example, sx[1:0] or sy[1:0] indicate the position of the scaled CL requested, and both are used as metadata to generate a final write address into the local buffer on data return from memory and after downscaling. The table below shows an example for a source block of 4×4 pixels, as shown on the following table for packed 4 bytes per pixel tile format.

Table 2

| Source fetch request | Scaled requests to memory (4x4 per CL for packed formats) [x,y] | sx[1:0] | sy[1:0] |
|---|---|---|---|
| [0,0] | [0,0] | 0 | 0 |
| | [4,0] | 1 | 0 |
| | [8,0] | 2 | 0 |
| | 12.0] | 3 | 0 |
| | [0,4] | 0 | 1 |
| | [4,4] | 1 | 1 |
| | [8,4] | 2 | 1 |
| | 12.4] | 3 | 1 |
| | [0,8] | 0 | 2 |
| | [4,8] | 1 | 2 |
| | [8,8] | 2 | 2 |
| | 12.8] | 3 | 2 |
| | [0,12] | 0 | 3 |
| | [4,12] | 1 | 3 |
| | [8,12] | 2 | 3 |
| | [12,12] | 3 | 3 |

Optionally and preliminarily, once the CLs are received at the VOFD, process 700 may include “downsample the chroma subsample scheme” 706 to perform the downsampling before the downscaling if simultaneous downscaling-downsampling is not going to be performed. The downsampling from color subsampling scheme format 444 to 420 may reduce local storage capacity requirements and area, and may reduce power consumption. This downsampling may involve downsampling the U and V components or channels to keep only one U and V pixel for every four luma pixels, which translates to a scale factor of x2 (for each x and y direction for a block of pixels). The downsampling may be performed by selecting pixel locations at fixed intervals, such as every fourth pixel in a linear cache line, or lower pixel for every 2x2 pixels when tiled. Many variations may be used.

Process 700 next may include “downscale the video using inline dedicated hardware downscaling circuitry” 708. This may include “input full resolution image data into downscaler” 710, where the image data of the CLs are placed into input registers of the downscaling circuitry, and as described above. This also may include using a downscaling mode or algorithm such as bilinear average, fixed pixel, nearest neighbor modes, or any other downscaling algorithm that can operate within the parameters described herein.

The downscaling 708 may include “downscale using at least one predetermined scale factor” 712, and as mentioned, this may include x2 or x4 scale factors, or other scale factors, chosen depending on the desired balance between performance and quality.

The downscaling 708 also optionally may include “simultaneously downsample chroma subsampling scheme” 714 to simplify the source fetch unit and to reduce the gate count of the hardware on the VOFD 204 for example. As mentioned for input 444 source formats, the color subsampling scheme may be downsampled to 420 by one example, while also performing the downscaling, and rather than using a separate upstream downsampling unit 216 before the downscaling to perform the downsampling. The parameters for this one-shot downscaling-downsampling are provided on the following table that compares one-shot downscaling-downsampling and downscaling alone, and compared at two different scale factors (x4, x2).

Table 3

| | | Chroma (x4 side) | | | Chroma (x2 side) | | |
|---|---|---|---|---|---|---|---|
| | | Input | Output | Scale/ Shift | Input | Output | Scale/ Shift |
| | | x4 (x2 downsample to 420 format) | | | x2 (x2 downsample to 420 format) | | |
| Packed formats (444) | Downscale and Downsample in one shot (chroma) | 8x8 | 1 | 6 | 4x4 | 1 | 4 |
| Formats already in 420 format | Downscale only (for both luma and chroma) | 4x4 | 1 | 0 | 4x4 | 2x2 | 0 |

As shown on the table above, the one-shot operation on 444 image data combines downscaling and downsampling only to the chroma surfaces or channels. This can be accomplished by multiplying the downscaling scale factor (here ×4) by a subsample color scheme conversion factor, which is ×2 (on a block side) since converting from 444 format to 420 format reduces the chroma samples in a typical 4×2 block from 8 chroma samples to 2 chroma samples. Thus, 4 × 2 = ×8 scale factor (or 16× for total block area) for a single downscaling 8 × 8 block of pixels. When the downscaling factor is ×2, then the one-shot scaling factor is 2 × 2 = ×4 scale factor. The luma downscaling remains the same where a 4 × 4 downscaling block of pixels is reduced to a single pixel.

The table above also shows the bit shift to use to perform the downscaling for the one-shot downscaling. For example, a 8 × 8 to 1 pixel downscaling operation may be performed by computing: Σ(pix[i] /64 (for i from 0 to 64) where the division is performed by doing a binary shift right of 6 bits.

During or after the downscaling processing, process 700 may have the downscaler 220 or other component “remove unneeded data” 716 to reduce the computational load at the first pass on the encoder. By one form, least significant bits (LSBs) may be downsampled or dropped 718 to reduce the bit-depth of the downscaled values. This may be performed to a sum of pixel values before the sum is divided (bit shifted) to determine the downscaled value for a pixel block, such as a 8 × 8 pixel block for the one-shot operation as mentioned. Alternatively, the LSBs can be dropped after the downscaled value is generated by the division operation. This may be performed when it is desirable to reduce the initial bit-depths of the pixel image data at 10, 12, 16, or more bits down to 8 bits for a smaller computational load at the encoder. The downscaler 220 or other component also may drop 720 redundant chroma CLs as well if fixed pixel location downscaling is being performed and it is known which CLs cannot have the downscaled value. Also, alpha channel data may be dropped 722. This data is not needed during fast first pass downscaled encoding and only results in wasted computational load and power consumption, and decreased performance. This unneeded data also may be removed as part of downscaling operations to save on storage space.

The process 700 may include “place downscaled image data into on-chip local buffer without use of external memory” 724. Every time a pixel is to be maintained after downscaling (or output from downscaling circuitry 220), it may be added to a current downscaled CL being stored in the local buffer. Once again, this uses the tagRAM tags to track the now downscaled CLs and place them from the downscaler and into the local buffer. The buffer does not necessarily hold the CLs in a particular order, and may enter CLs into the buffer on a FIFO or other efficient basis. The tags indicate the positions of the CLs in a frame and therefore maintain the frame position order of the CLs relative to each other.

The process 700 may include “collect downscaled image data without using external memory” 726, and where the collecting operation 726 may include “use cache lines” 728. Thus, CLs may be requested by the engine and are identified by their tags. The CLs are then retrieved from the local buffer and provided to a CL gather/packer unit. The CLs are collected to form 32 × 32 (or other size) blocks of image data expected by the encoder.

Specifically, the pixel locations previously occupied by the unneeded data still may be expected by the encoder. Thus, the collecting operation 726 also may include “pack place holders in addition to downscaled image data to achieve encoder-expected image data group format and sizes” 730. This then includes filling at least some of the removed data with zeros. Also, when 444 format is expected by the encoder rather than the 420 downscaled data, an upsampling stage may be performed to upscale 420 format data back to 444 data. Thus a second copy of the chroma CLs are generated and used to fill pixel blocks, such as the 32 × 32 pixel blocks, expected by the encoder. Once the 32 × 32 blocks are filled, the downscaled image data can be provided to the encoder for downscaled fast first pass encoding.

The process 700 may include “provide downscaled image data to encoder without using external memory” 732. Here, the packed pixel blocks may be provided to the encoder as cache lines, and provided upon receiving cache line requests from the encoder for example. By one form, the encoder is blind to the use of the downscaling and assumes the data is being received from a cache. This diversion is accomplished by the source fetch unit by having the format engine respond to cache line requests from the encoder.

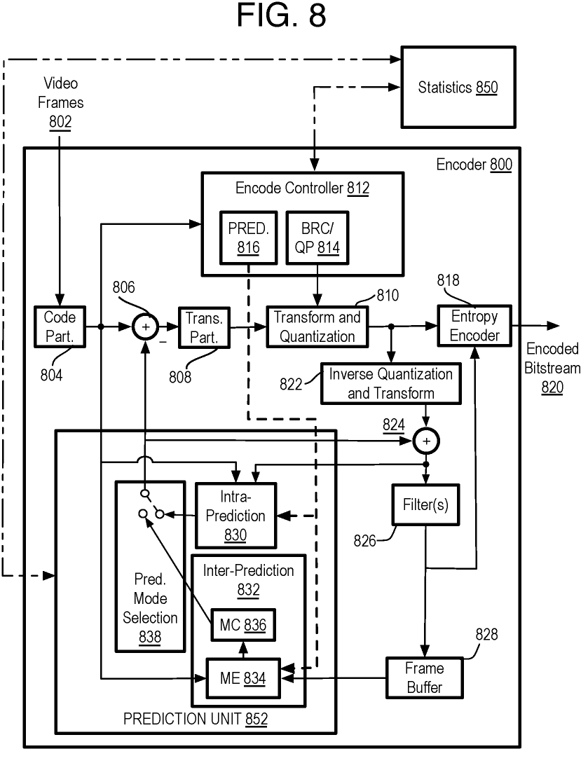

The process 700 then may perform encoder-side operations 734 that may include “encode downscaled image data in a first pass” 736. Referring to FIG. 8 for example, an encoder 800 may be used to perform the image data compression in both the first and subsequent encoding passes described herein. The encoder may be compatible with a video compression-decompression (codec) standard such as, for example, HEVC (High Efficiency Video Coding/H.265/MPEG-H Part 2), AVC (Advanced Video Coding/H.264/MPEG-4 Part 10), VVC (Versatile Video Coding/MPEG-I Part 3), VP8, VP9, Alliance for Open Media (AOMedia) Video 1 (AV1), the VP8/VP9/AV1 family of codecs, and so forth

As shown, encoder 800 receives input video 802 from the source fetch unit 202 and includes a coding partition unit 804, subtract or adder 806, transform partitioner unit 808, a transform and quantization module 810, an encoder controller 812 with a QP or bitrate control unit (BRC/QP unit) 814 and a prediction control unit 816, and an entropy encoder 818. A decoding loop of the encoder 800 includes at least an inverse quantization and transform module 822, adder 824, in-loop filters 826, a frame buffer 828, and a prediction unit 852 with an intra-prediction module 830, an inter-prediction module 832, and a prediction mode selection unit 838.

In operation, encoder 800 receives input video 802 which is partitioned by code partitioner 116, and then provided to encode controller 812, intra-prediction module 830, and inter-prediction module 832. As shown, prediction mode selection module 838 (e.g., via a switch), may select, for a coding unit or block or the like between an intra-prediction mode and an inter-prediction mode from their respective mode units 830 and 832. Based on the mode selection, a predicted portion of the video frame is differenced via differencer (or adder) 806 with the original portion of the video frame to generate a residual. The residual may be transferred to the transform partitioner 808 that divides the frames into transform blocks, and then the transform and quantization module 810, which may transform (e.g., via a discrete cosine transform or the like) the residual to determine transform coefficients and quantize the transform coefficients using the frame or block level QP received from the BRC/QP unit 814.

The BRC/QP unit 814 sets the QP index for quantization so that the encoding meets a bit rate set by other transmission applications, and particularly to maintain a certain desired target frame bitrate, and the QP may change from frame to frame to do this. In more detail, the transform coefficients are quantized into a discrete set of values (or quantization steps) similar to a rounding operation thereby causing lossy compression of the residuals. The QP is used to form a Qstep value that usually indicates the number of discrete steps, and in turn the size of the step, to use. The larger the QP, the larger the Qstep, and the less detail and accuracy is preserved although computational load decreases. The smaller the QP, however, the smaller the step, and more detail with more computational load is obtained. The QP can be set as a target QP which will be roughly the average QP value for a frame. The encode controller 812 provides the QP values to the transform and quantization module 810. The quantized transform coefficients may be encoded via entropy encoder 818 and packed into encoded bitstream 820.

Furthermore at a decoding loop, the quantized transform coefficients are inverse quantized and inverse transformed via inverse quantization and transform module 822 to generate a reconstructed residual. The reconstructed residual may be combined with the aforementioned predicted portion at adder 824 to form a reconstructed portion, which may be filtered using in-loop filters 826 to generate a reconstructed frame. The reconstructed frame is then saved to frame buffer 828 to be used as a reference frame by the prediction unit 852 for encoding other portions of the current or other video frames.

It should be noted that since downscaled video frames are input to the encoder on the first pass, the reference frames placed in the reference frame buffer 828 may be downscaled video frame sizes as well, such as the 480 × 270 pixel frame sizes mentioned herein with encoder pipeline 102.

In an implementation, coding parameters (or encoder settings) are determined for the encoding of source sequences and indicate encode decisions used to encode the video sequence. This may be performed on a block by block or frame by frame basis depending on the parameter or setting. This includes setting of the QP as well as prediction data.

As to the prediction data settings, the inter-prediction unit 832 may have a motion estimation unit 834 that compares the input video frames to the reference frames to find matching image data. This is accomplished by performing a block-based search to find matching blocks, and a motion vector indicates the motion of a block of image from a position on the reference frame to another position on a current frame being analyzed. The motion compensation unit 836 then generates a prediction block to be used to form the residual. For the intra-prediction unit 830, data of other blocks on the same frame are selected and used to form a prediction for a current block on the frame. The data of the other blocks can be obtained in a number of different ways, including through inter-prediction. The prediction mode selection unit 838 may receive a number of candidate predictions from the inter-prediction unit 832, intra-prediction unit 830, or both. The selection then may be based on performance and/or quality targets. These prediction operations have a number of predetermined settings that can be adjusted in a subsequent pass by monitoring these settings and results in the fast first pass. Thus by one form for the first pass, these encoder settings may be set by using typical techniques.

Otherwise, further details of the encoder modules and units are known to those of skill in the art and are not discussed further herein with respect to FIG. 8 for the sake of clarity in presentation.

Returning to process 700, the process 700 may include “generate statistics” 738. Here, a statistics unit 850, similar to statistics unit 110, may monitor the QP unit and prediction unit 852 at the encoder 800. This may include saving the QP used for each frame or GOP, or otherwise whenever the QP was changed during the video encoding of the downscaled frames. Also as mentioned, the image content complexity could be monitored as well to determine whether a high or low bitrate should be used for a frame.

As to the prediction data, a number of different parameters may be monitored, including reference frame selection, matching block search parameters such as image area or patterns, matching reference blocks, motion vectors, and prediction blocks for inter-prediction, and neighbor block selection (including motion vectors when used to select the neighbor blocks) and intra block predictions for intra-prediction. For the prediction mode selection unit 838, certain candidate predictions may be added or removed, or a prediction selection itself may be provided.

The process 700 may include “use the statistics to set encoder settings” 740. This may include “set QP value” 742. Here the QP for one or more, or all frames, from the first pass may be provided to the encoder for use as the frame QPs for the subsequent full resolution pass. Instead, or in addition, the setting of encoder settings statistics 740 may include “set prediction settings” 744. Here, the prediction data may be used, and may be upscaled to full resolution size, such as with motion vectors, when needed. As mentioned, the settings may be any one or more of those prediction parameters that can be monitored in the first pass, saved, and set again in the subsequent pass. Thus, by one example, this may include “set motion search candidate data” 746. It should be noted that the setting of the encoder settings may leverage first pass hierarchical frame selection where I-frames, P-frames, and B-frames receive different treatment during prediction and provide alternative inter-prediction candidates within a GOP for example. The downscaled first pass may already have performed the best reference frame selection, and this selection can be immediately used at the encoder in the subsequent pass rather than having multiple candidates for the GOP frame type.

The encoder settings may be found in software or firmware provided from the hardware initialization data (state programming) for the full resolution pass, and particularly may be set into one or more abstraction layers, parameter sets, and so forth of the encoder for compression operations.

Process 700 may include “receive full resolution version of the video frame” 748. Here, the full resolution video sequence of frames may be fetched from an internal memory, such as a RAM or cache, or from an external memory whether from non-volatile memory such as a hard drive, flash drive, and so forth, or from non-volatile memory such as a main external encoding frame RAM. Many variations are contemplated.

Process 700 may include “encode full resolution version of the video frame” 750, where the full resolution video frames are pre-processed and/or formatted, including RGB to YUV conversion or color subsampling scheme downsampling conversion if desired, re-packed if needed, and then provided to the encoder and encoded at the encoder with the encoder settings mentioned above obtained from the first pass.

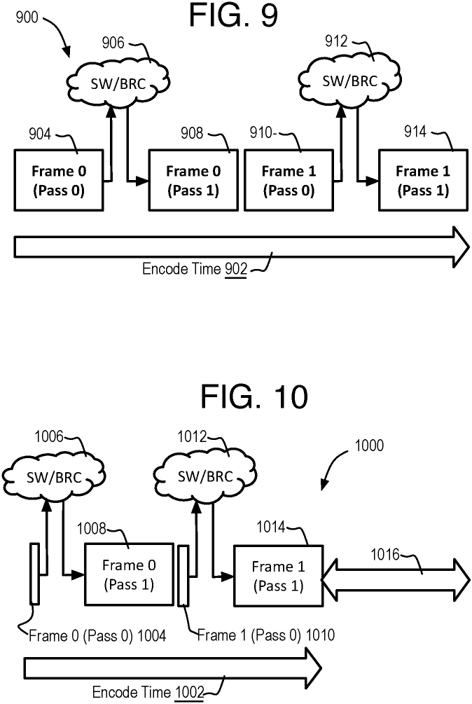

Referring to FIGS. 9-10, the results of using the disclosed device and method is significant reduction in latency. For example, a conventional video coding timing diagram 900 shows a conventional time line where a full resolution first pass 0 for a first frame 0 904 or frame 1 910 is performed before a software-based bitrate control 906 or 912 for bitrate control adjustment respectively, and then a second pass 1 908 or 914.

The total encode time 902 of the conventional system is shown and can be compared to the total encode time 1002 on a video coding timing diagram 1000 generated by using the disclosed method and system. Specifically, the same elements are numbered similarly and do not need to be described again except to note the much shorter first pass frames 0 1004 and 1010 that results in a difference in total encode time 1016 thereby depicting the improvement in the reduction of latency. A table 2 below shows clock timing:

Table 4

| | |
|---|---|
| Full resolution subsequent pass encode time for a block | N clocks |
| Fast pass encode time for same sized, downscaled block (×4) | N clocks |
| Fast pass penalty on the normal pass (×4 each side) | N/16 clocks |
| Two pass solution at full resolution: encode time per block | N + N = 2 N clocks |

where the fast pass encode time includes the time to perform the downscaling, and the fast pass penalty refers to downscaling ×4 and 16×.

| Subsequent pass + Fast pass encode time per block | N + N/16 = 1.0625 N clocks |
|---|---|
| Effective power/performance gain with Fast encode | ~46.875% |

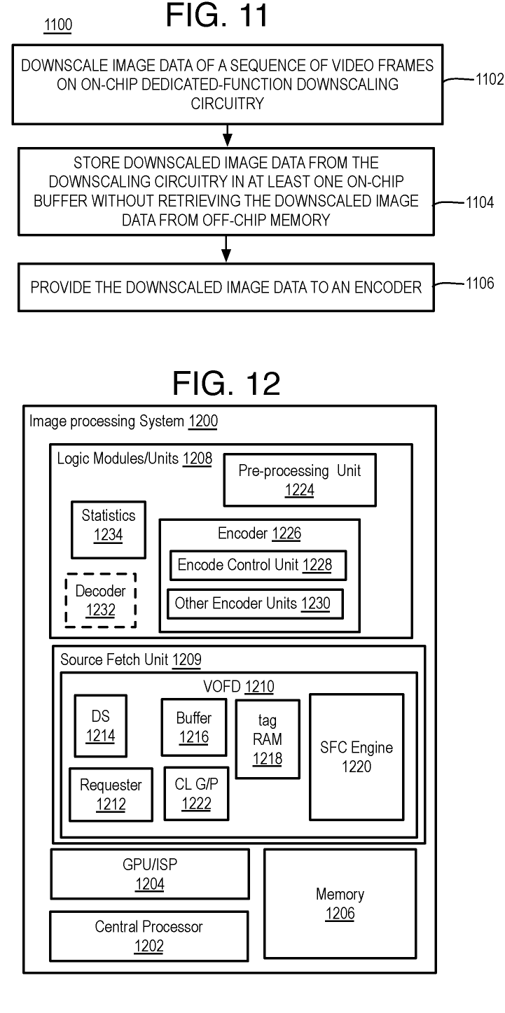

Referring to FIG. 11, an example process 1100 of video coding with inline downscaling hardware is described herein. In the illustrated implementation, process 1100 may include one or more operations, functions, or actions as illustrated by one or more of operations 1102 to 1106, numbered evenly. By way of non-limiting example, process 1100 may be described herein with reference to example image processing systems or devices 100, 200, 600, 800, and 1200 respectively of FIGS. 1, 2, 6, 8, and 12, where relevant.

Referring to FIG. 12, an example image processing system or device 1200 for video coding is arranged in accordance with at least some implementations of the present disclosure to operate process 1100. As shown in FIG. 12, system 1200 may include a central processor 1202, shared or dedicated video processors such as graphics processing unit (GPU) and/or image signal processing (ISP) unit 1204, a memory 1206, logic modules or units 1208, and a source fetch unit 1209 with a video coding on-the-fly downscaling unit (VOFD) 1210 such as VOFD 106 or 204 described above. The logic units 1208 may include a pre-processing unit 1224, encoder 1226 with an encode control unit 1228 and other encoder units 1230, a statistics unit 1234, and optionally a decoder 1232. The VOFD 1210 may have a requester unit 1212, downscaler or downscaling circuitry 1214, a buffer 1216, a tagRAM unit 1218, a source format converter engine 1220 and a CL gatherer packer unit 1222. These components of system 1200 may have similar names to those units so named on system 100 or 200, and therefore perform the same or similar functions.

The VOFD 1210 may be provided in hardware with instructions thereon in firmware as described above. The VOFD may include any number and type of video, image, or graphics hardware processing units that may provide the operations as discussed herein. Such operations may be implemented via hardware, firmware, or a combination thereof. For example, downscaling circuitry 1214 may include circuitry dedicated to downscaling source video frames without the use of software instructions as described above. GPU/ISP 1204 may include any number and type of processing units or modules that may provide image processing tasks, such as pixel encoding tasks for the encoder 1226, and central processor 1202 may include any number and type of processing units or modules that may provide control and other high level functions for system 1200 and/or provide any operations as discussed herein. Memory 1206 may be any type of memory such as volatile memory (e.g., Static Random Access Memory (SRAM), Dynamic Random Access Memory (DRAM), etc.) or non-volatile memory (e.g., hard drive, flash memory, etc.), and so forth. In a non-limiting example, memory 1206 may be implemented by cache memory.

Returning to process 1100, process 1100 may include “downscale image data of a sequence of video frames on on-chip dedicated-function downscaling circuitry” 1102. The source images or frames may be received using transmission circuitry forming CL G/P unit 1222 so that the frames may be retrieved using cache line instructions, operations, or commands to move the video frames onto the VOFD 1210 even though no cache is being used for this purpose. The downscaling circuitry 1214 then may downscale the image data. By one form, a single fixed algorithm or multiple alternative algorithms could be used, such as bilinear and fixed pixel as described above.

Process 1100 may include “store downscaled image data from the downscaling circuitry in at least one on-chip buffer without retrieving the downscaled image data from off-chip memory” 1104. By one form the buffer is a type of on-chip, on-board, or local latch-based RAM memory but is not a cache. By one example form, the buffer stores two 32×32 blocks of data in 420 color subsampling scheme in YUV color space with an 8-bit depth per image value. The downscaled image data then be provided to the engine 1220 and CL G/P unit 1222 by using cache lines again.

Process 1100 may include provide the downscaled image data to an encoder 1106. Specifically, once the images have been downscaled, the images may be formatted and/or pre-processed as expected by the encoder and as described above. This also may be performed by using cache lines to collect the image data from the buffer into pixel block sizes expected by the encoder and to provide the image data in the form of cache lines to the encoder.

The encoder 1226 then may receive and encode the downscaled frames in a fast first pass using the downscaled reference frames and hardware initialization that sets various encoder settings such as quantization related setting and prediction related settings also described above. The statistics of the encoding are then gathered and analyzed to determine encoder setting for a full resolution second encoding pass. The video frames then may bypass the downscaling and be encoded in the second pass in the full resolution version of the image data and with encoder settings set depending on the encoder statistics.

Various components of the systems described herein may be implemented in software, firmware, and/or hardware and/or any combination thereof unless stated otherwise, particularly for the downscaling circuitry that is provided in hardware without operation by software. A more particular explanation of hardware is described below. Otherwise, for example, various components of the systems or devices discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components for transmission of image data between components, encoder support components, applications that activate the encoding, and the like that have not been depicted in the interest of clarity.

While implementation of the example processes 700 and 1100 discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality. Component herein also may refer to processors and other specific hardware devices.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

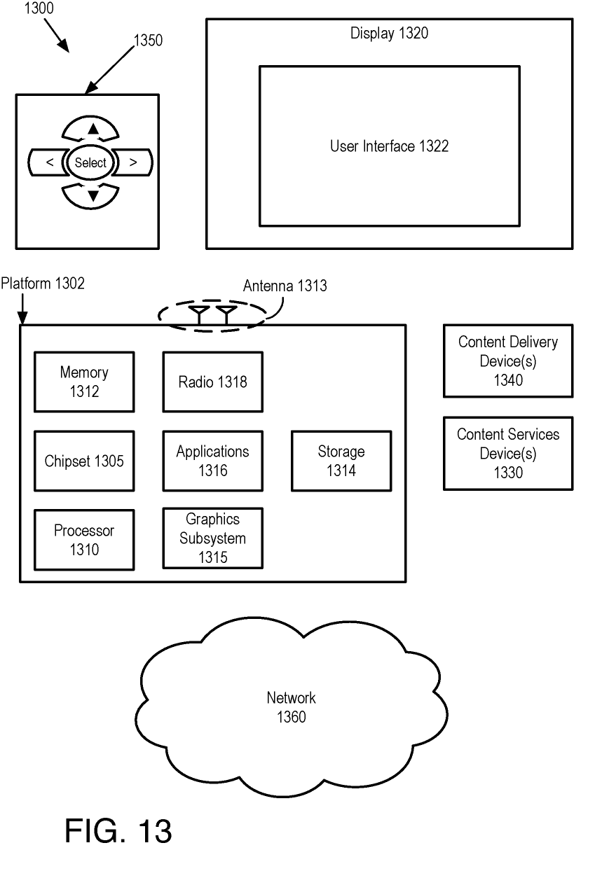

Referring to FIG. 13, an example system 1300 is arranged in accordance with at least some implementations of the present disclosure. In various implementations, system 1300 may be a mobile system although system 1300 is not limited to this context. For example, system 1300 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1300 includes a platform 1302 coupled to a display 1320. Platform 1302 may receive content from a content device such as content services device(s) 1330 or content delivery device(s) 1340 or other similar content sources. A navigation controller 1350 including one or more navigation features may be used to interact with, for example, platform 1302 and/or display 1320. Each of these components is described in greater detail below.

In various implementations, platform 1302 may include any combination of a chipset 1305, processor 1310, memory 1312, antenna 1313, storage 1314, graphics subsystem 1315, applications 1316 and/or radio 1318. Chipset 1305 may provide intercommunication among processor 1310, memory 1312, storage 1314, graphics subsystem 1315, applications 1316 and/or radio 1318. For example, chipset 1305 may include a storage adapter (not depicted) capable of providing intercommunication with storage 1314.

Processor 1310 may be implemented as a Complex Instruction Set Computer (CISC) or Reduced Instruction Set Computer (RISC) processors, ×86 instruction set compatible processors, multi-core, or any other microprocessor or central processing unit (CPU). In various implementations, processor 1310 may be dual-core processor(s), dual-core mobile processor(s), and so forth.

Memory 1312 may be implemented as a volatile memory device such as, but not limited to, a Random Access Memory (RAM), Dynamic Random Access Memory (DRAM), or Static RAM (SRAM).

Storage 1314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1314 may include technology to increase the storage performance enhanced protection for valuable digital media when multiple hard drives are included, for example.

Graphics subsystem 1315 may perform processing of images such as still or video for display. Graphics subsystem 1315 may be a graphics processing unit (GPU) or a visual processing unit (VPU), for example. An analog or digital interface may be used to communicatively couple graphics subsystem 1315 and display 1320. For example, the interface may be any of a High-Definition Multimedia Interface, DisplayPort, wireless HDMI, and/or wireless HD compliant techniques. Graphics subsystem 1315 may be integrated into processor 1310 or chipset 1305. In some implementations, graphics subsystem 1315 may be a stand-alone device communicatively coupled to chipset 1305.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further implementations, the functions may be implemented in a consumer electronics device.

Radio 1318 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1318 may operate in accordance with one or more applicable standards in any version.

In various implementations, display 1320 may include any television type monitor or display. Display 1320 may include, for example, a computer display screen, touch screen display, video monitor, television-like device, and/or a television. Display 1320 may be digital and/or analog. In various implementations, display 1320 may be a holographic display. Also, display 1320 may be a transparent surface that may receive a visual projection. Such projections may convey various forms of information, images, and/or objects. For example, such projections may be a visual overlay for a mobile augmented reality (MAR) application. Under the control of one or more software applications 1316, platform 1302 may display user interface 1322 on display 1320.

In various implementations, content services device(s) 1330 may be hosted by any national, international and/or independent service and thus accessible to platform 1302 via the Internet, for example. Content services device(s) 1330 may be coupled to platform 1302 and/or to display 1320. Platform 1302 and/or content services device(s) 1330 may be coupled to a network 1360 to communicate (e.g., send and/or receive) media information to and from network 1360. Content delivery device(s) 1340 also may be coupled to platform 1302 and/or to display 1320.

In various implementations, content services device(s) 1330 may include a cable television box, personal computer, network, telephone, Internet enabled devices or appliance capable of delivering digital information and/or content, and any other similar device capable of uni-directionally or bi-directionally communicating content between content providers and platform 1302 and/display 1320, via network 1360 or directly. It will be appreciated that the content may be communicated uni-directionally and/or bi-directionally to and from any one of the components in system 1300 and a content provider via network 1360. Examples of content may include any media information including, for example, video, music, medical and gaming information, and so forth.

Content services device(s) 1330 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1302 may receive control signals from navigation controller 1350 having one or more navigation features. The navigation features of may be used to interact with user interface 1322, for example. In various implementations, navigation may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of may be replicated on a display (e.g., display 1320) by movements of a pointer, cursor, focus ring, or other visual indicators displayed on the display. For example, under the control of software applications 1316, the navigation features located on navigation may be mapped to virtual navigation features displayed on user interface 1322, for example. In various implementations, may not be a separate component but may be integrated into platform 1302 and/or display 1320. The present disclosure, however, is not limited to the elements or in the context shown or described herein.

In various implementations, drivers (not shown) may include technology to enable users to instantly turn on and off platform 1302 like a television with the touch of a button after initial boot-up, when enabled, for example. Program logic may allow platform 1302 to stream content to media adaptors or other content services device(s) 1330 or content delivery device(s) 1340 even when the platform is turned “off.” In addition, chipset 1305 may include hardware and/or software support for 5.1 surround sound audio and/or high definition 13.1 surround sound audio, for example. Drivers may include a graphics driver for integrated graphics platforms. In various implementations, the graphics driver may include a peripheral component interconnect (PCI) Express graphics card.

In various implementations, any one or more of the components shown in system 1300 may be integrated. For example, platform 1302 and content services device(s) 1330 may be integrated, or platform 1302 and content delivery device(s) 1340 may be integrated, or platform 1302, content services device(s) 1330, and content delivery device(s) 1340 may be integrated, for example. In various implementations, platform 1302 and display 1320 may be an integrated unit. Display 1320 and content service device(s) 1330 may be integrated, or display 1320 and content delivery device(s) 1340 may be integrated, for example. These examples are not meant to limit the present disclosure.

In various implementations, system 1300 may be implemented as a wireless system, a wired system, or a combination of both. When implemented as a wireless system, system 1300 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1300 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 13.

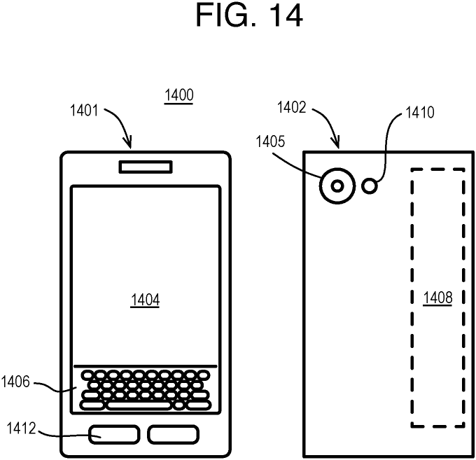

As described above, system 1300 may be embodied in varying physical styles or form factors. FIG. 14 illustrates an example small form factor device 1400, arranged in accordance with at least some implementations of the present disclosure. In some examples, system 1300 may be implemented via device 1400. In other examples, system 100 or portions thereof may be implemented via device 1400. In various implementations, for example, device 1400 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computer, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 14, device 1400 may include a housing with a front 1401 and a back 1402. Device 1400 includes a display 1404, an input/output (I/O) device 1406, and an integrated antenna 1408. Device 1400 also may include navigation features 1412. I/O device 1406 may include any suitable I/O device for entering information into a mobile computing device. Examples for I/O device 1406 may include an alphanumeric keyboard, a numeric keypad, a touch pad, input keys, buttons, switches, microphones, speakers, voice recognition device and software, and so forth. Information also may be entered into device 1400 by way of microphone (not shown), or may be digitized by a voice recognition device. As shown, device 1400 may include a camera 1405 (e.g., including a lens, an aperture, and an imaging sensor) and a flash 1410 integrated into back 1402 (or elsewhere) of device 1400. In other examples, camera 1405 and flash 1410 may be integrated into front 1401 of device 1400 or both front and back cameras may be provided. Camera 1405 and flash 1410 may be components of a camera module to originate image data processed into streaming video that is output to display 1404 and/or communicated remotely from device 1400 via antenna 1408 for example.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as IP cores, may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

In example 1, a method of video coding comprises downscaling image data of a sequence of video frames on on-chip dedicated-function downscaling circuitry; storing downscaled image data from the downscaling circuitry in at least one on-chip buffer without retrieving the downscaled image data from off-chip memory; and providing the downscaled image data to an encoder.

In example 2, the subject matter of example 1 wherein the method comprises determining encoder statistics of the encode of the downscaled image data, and encoding a full resolution version of the image data with encoder settings set depending on the encoder statistics.

In example 3, the subject matter of example 1 or 2 wherein downscaled image data from the at least one buffer is provided to at least one processor performing the encoding of an encoder directly without placing the downscaled image data into another memory.

In example 4, the subject matter of any one of examples 1 to 3 wherein the at least one buffer is a latch-based buffer.

In example 5, the subject matter of any one of examples 1 to 4 wherein the at least one buffer is a type of random-access memory (RAM).

In example 6, the subject matter of any one of examples 1 to 5 wherein the at least one buffer holds downscaled image data of brightness or color channel or both in one or more fixed 32 x 32 pixel blocks of 8 bits per pixel.

In example 7, the subject matter of any one of examples 1 to 6 wherein the downscaling circuitry receives a predetermined scaling factor.

In example 8, the subject matter of any one of examples 1 to 7 wherein the downscaling comprises simultaneously downsampling a subsampling color scheme from a single 444 format to a format with a lower number of color variations.

In example 9, the subject matter of any one of examples 1 to 8 wherein the downscaling comprises converting initial image value bit depth of the image data to a lower bit depth in the downscaled image data.

In example 10, the subject matter of any one of examples 1 to 9 wherein the downscaling circuitry is arranged to downsample subsample color schemes to 420 and bit depth of single pixel chroma or luminance values to 8 bit.

In example 11, a computer-implemented system of video coding comprises dedicated-function downscaling circuitry to downscale image data of a sequence of video frames; at least one on-chip buffer to hold the downscaled image data directly provided from the downscaling circuitry; and transmission circuitry communicatively coupled to the at last one buffer and downscaling circuitry, and being arranged to provide the downscaled image data from the at least one buffer to an encoder.

In example 12, the subject matter of example 11 wherein the downscaling circuitry is arranged to implement downscaling of 4×4 to 1 pixel or ×2 to 1 pixel or alternatively to both.

In example 13, the subject matter of example 11 wherein the downscaling circuitry performs 8×8 to 1 pixel downscaling to simultaneously downsample 444 color subsampling scheme format to 420 color subsampling scheme format.

In example 14, the subject matter of any one of example 11 to 13 wherein the transmission circuitry is arranged to operate by using cache line operations to move image data without the use of a cache.

In example 15, the subject matter of any one of example 11 to 14 wherein cache lines requests are used to obtain full resolution versions of the image data to be downscaled.

In example 16, the subject matter of example 15 wherein a number of cache line requests are upscaled to factor an amount of image data to be downscaled.

In example 17, the subject matter of any one of example 11 to 16 wherein cache lines are used to collect downscaled image data from the at least one buffer.

In example 18, the subject matter of any one of example 11 to 17 wherein cache lines are used to transmit the downscaled image data to the encoder.

In example 19, a video coding device comprises dedicated-function downscaling circuitry to generate downscaled image data of a sequence of video frames before encoding the downscaled image data; and at least one non-transitory machine readable medium comprising a plurality of instructions that, in response to being executed on a computing device, cause the computing device to operate by encoding the downscaled image data without retrieving the downscaled image data from off-chip memory; determining encoder statistics of the encode of the downscaled image data; and encoding a full resolution version of the image data with encoder settings set depending on the encoder statistics.

In example 20, the subject matter of example 19 wherein the downscaling circuitry is arranged to remove data from the downscaled image data before encoding, wherein the removed data is at least one of: one or more least significant bits in image data values, redundant chroma data, and alpha channel data, and packer unit arranged to replace removed data with zeros to accompany the downscaled image data to form blocks of data with sizes expected by the encoder.

In example 21, the subject matter of example 19 or 20 wherein the downscaling circuitry operates at least one of: a bilinear downscaling algorithm, nearest neighbor downscaling algorithm nearest to an average pixel value, and a fixed pixel location downscaling algorithm within individual downscaling blocks.

In example 22, the subject matter of any one of example 19 to 21 wherein the encoder settings used to encode the downscaled image data are based on a downscaled frame size relative to a size of the video frames.

In example 23, the subject matter of any one of example 19 to 22 wherein the encoder settings comprise at last one quantization parameter (QP) or quantization step value to control a bitrate to stream the video sequence.

In example 24, the subject matter of any one of example 19 to 23 wherein the encoder settings relate to intra or inter-prediction data determined on the downscaled image data and to be used to encode a full resolution version of the downscaled image data.

In example 25, the subject matter of any one of example 19 to 24 wherein the encoder settings relate to inter-prediction data motion vectors.

In example 26, a device or system includes a memory and a processor to perform a method according to any one of the above implementations.

In example 27, at least one machine readable medium includes a plurality of instructions that in response to being executed on a computing device, cause the computing device to perform a method according to any one of the above implementations.

In example 28, an apparatus may include means for performing a method according to any one of the above implementations.

It will be recognized that the implementations are not limited to the implementations so described, but can be practiced with modification and alteration without departing from the scope of the appended claims. For example, the above implementations may include specific combination of features. However, the above implementations are not limited in this regard and, in various implementations, the above implementations may include the undertaking only a subset of such features, undertaking a different order of such features, undertaking a different combination of such features, and/or undertaking additional features than those features explicitly listed. The scope of the implementations should, therefore, be determined with reference to the appended claims, along with the full scope of equivalents to which such claims are entitled.

What is claimed is:

1. A method of video coding comprising:
downscaling image data of a sequence of video frames on on-chip dedicated-function downscaling circuitry;
storing downscaled image data from the downscaling circuitry in at least one on-chip buffer without retrieving the downscaled image data from off-chip memory; and
providing the downscaled image data to an encoder.

2. The method of claim 1 comprising determining encoder statistics of the encode of the downscaled image data, and encoding a full resolution version of the image data with encoder settings set depending on the encoder statistics.

3. The method of claim 1 wherein downscaled image data from the at least one buffer is provided to at least one processor performing the encoding of an encoder directly without placing the downscaled image data into another memory.

4. The method of claim 1 wherein the at least one buffer is a latch-based buffer.

5. The method of claim 1 wherein the at least one buffer is a type of random-access memory (RAM).

6. The method of claim 1 wherein the at least one buffer holds downscaled image data of brightness or color channel or both of up to one or more 32 × 32 pixel blocks of 8 bits per pixel.

7. The method of claim 1 wherein the downscaling circuitry receives a predetermined scaling factor.

8. The method of claim 1 wherein the downscaling comprises simultaneously downsampling a subsampling color scheme from a single 444 format to a format with a lower number of color variations.

9. The method of claim 1 wherein the downscaling comprises converting initial image value bit depth of the image data to a lower bit depth in the downscaled image data.

10. The method of claim 1 wherein the downscaling circuitry is arranged to downsample subsample color schemes to 420 and bit depth of single pixel chroma or luminance values to 8 bit.

11. A computer-implemented system of video coding comprising:
dedicated-function downscaling circuitry to downscale image data of a sequence of video frames;
at least one on-chip buffer to hold the downscaled image data directly provided from the downscaling circuitry; and
transmission circuitry communicatively coupled to the at last one buffer and downscaling circuitry, and being arranged to provide the downscaled image data from the at least one buffer to an encoder.

12. The system of claim 11 wherein the downscaling circuitry is arranged to implement downscaling of 4×4 to 1 pixel or 2×2 to 1 pixel.

13. The system of claim 11 wherein the downscaling circuitry performs 8×8 to 1 pixel downscaling to simultaneously downsample 444 color subsampling scheme format to 420 color subsampling scheme format.

14. The system of claim 11 wherein the transmission circuitry is arranged to operate by using cache line operations to move image data without the use of a cache.

15. The system of claim 14 wherein cache lines requests are used to obtain full resolution versions of the image data to be downscaled.

16. The system of claim 15 wherein a number of cache line requests are upscaled to factor an amount of the downscaling.

17. The system of claim 14 wherein cache lines are used to collect downscaled image data from the at least one buffer.

18. The system of claim 14 wherein cache lines are used to transmit the downscaled image data to the encoder.

19. A video coding device comprising:
dedicated-function downscaling circuitry to generate downscaled image data of a sequence of video frames before encoding the downscaled image data; and
at least one non-transitory machine readable medium comprising a plurality of instructions that, in response to being executed on a computing device, cause the computing device to operate by:
encoding the downscaled image data without retrieving the downscaled image data from off-chip memory;
determining encoder statistics of the encode of the downscaled image data; and
encoding a full resolution version of the image data with encoder settings set depending on the encoder statistics.

20. The device of claim 19 wherein the downscaling circuitry is arranged to remove data from the downscaled image data before encoding, wherein the removed data is at least one of: one or more least significant bits in image data values, redundant chroma data, and alpha channel data, and packer unit arranged to replace removed data with zeros to accompany the downscaled image data to form blocks of data with sizes expected by the encoder.

21. The device of claim 19 wherein the downscaling circuitry operates at least one of: a bilinear downscaling algorithm, nearest neighbor downscaling algorithm nearest to an average pixel value, and a fixed pixel location downscaling algorithm within individual downscaling blocks.

22. The device of claim 19 wherein the encoder settings used to encode the downscaled image data are based on a downscaled frame size relative to a size of the video frames.

23. The device of claim 19 wherein the encoder settings comprise at last one quantization parameter (QP) or quantization step value to control a bitrate to stream the video sequence.

24. The device of claim 19 wherein the encoder settings relate to intra or inter-prediction data determined on the downscaled image data and to be used to encode a full resolution version of the downscaled image data.

25. The device of claim 19 wherein the encoder settings relate to inter-prediction data motion vectors.
